(19) United States
(12) Patent Application Publication
(10) Pub. No.: US 2025/0094943 A1
(43) Pub. Date: Mar. 20, 2025

(54) System and Method for Equitably Allocating a Financial Distribution to Multiple Investors Using a Payment System

(71) Applicant: Jeremy Roseberry, Boynton Beach, FL (US)

(72) Inventor: Jeremy Roseberry, Boynton Beach, FL (US)

(21) Appl. No.: 18/963,661

(22) Filed: Nov. 28, 2024

Related U.S. Application Data
(63) Continuation-in-part of application No. 17/052,772, filed on Nov. 3, 2020.
(60) Provisional application No. 62/694,363, filed on Jul. 5, 2018.
(60) Provisional application No. 62/787,563, filed on Jan. 2, 2019.
(60) Provisional application No. 62/854,886, filed on May 30, 2019.

(51) Int. Cl. G06Q 20/06; G06Q 40/04

(52) U.S. Cl. CPC G06Q 20/06; G06Q 40/04

(57) ABSTRACT

A computer-implemented method for creating equitable payment instructions for equitably distributing income from an income-producing security to an investor, the method including: receiving an income distribution from a security issuer of an income-producing security; transferring the income distribution to a custodian; retrieving transaction data; retrieving an investor share number; dividing the payment period into a sequence of share-intervals; assigning the transaction to a corresponding share-interval using the transaction data; calculating a ending share-interval value; identifying the ending share-interval value of the last share-interval of the payment; calculating a cumulative ending share-interval value for the investors; generating equitable payment instructions for the investor based on the calculated income payable; storing, in the memory, the equitable payment instructions; and transmitting the equitable payment instructions to the custodian for equitable distribution to the investor of the payable income.

### PRIORITY CLAIM

The present application is a continuation-in-part application that claims the priority benefit of U.S. utility patent application Ser. No. 17/052,772, filed Nov. 3, 2020, which in turn is a 371 National Stage Entry application of Patent Cooperation Treaty (PCT) application number PCT/US2019/040738, filed Jul. 5, 2019 and entitled, “System and Method for Equitably Allocating a financial Distribution to Multiple Investors Using a Payment Agent,” which in turn claims the priority benefit of United States U.S. provisional patent application No. 62/694,363 filed Jul. 5, 2018 and entitled “Method and System for Equitably Allocating Financial Distributions,” of U.S. provisional patent application No. 62/787,563 filed Jan. 2, 2019 and entitled “Investment Fund for Equitably Allocating Financial Distributions,” and of U.S. provisional patent application No. 62/854,886 filed May 30, 2019 and entitled “System and Method for Removing a Distribution from a Value of a Security,” the disclosures of which are incorporated herein by reference.

### INTRODUCTION

The prior art last holder of record payment system is the current payment system used for distributing income from income-generating securities, such as dividends, capital gains or interest payments, to investors. In this prior art payment system, when a distribution is paid by the issuer of a security, the income is paid only to the investors who hold the security on the last day of a payment period. The last holder of record payment system is only capable of identifying investors who own the security at the close of the market on the last day of the payment period, and it is only these holders who receive the entire distribution, irrespective of whether they owned the security for the entire income-generating period or only briefly. Investors who owned the security, but sold the security any time before the last day of the payment period receive no income, even though they were a legal owner of the security and are entitled to their share of income the security generated for the time they owned it.

While this prior art payment system has been used for decades, it poses significant technical limitations and inefficiencies in distributing income fairly and accurately to investors. One major issue is the inability of the last holder of record payment system to pay income to investors who owned a security but sold it prior to the ex-dividend date. In this scenario, because investors owned the security during the payment period, they should have an economic interest in the income generated for the period, but due to the prior art last holder of record payment system, many investors are not paid their share of income earned. This results in inequitable treatment of investors and prevents accurate income distribution equal to their economic interest in the income generated by the security for the time they owned it.

Another significant problem with the last holder of record payment system is that it artificially overvalues income-producing securities. Since unpaid distributions must be included in the value of the security for the prior art payment system to function, this creates artificially inflated prices that do not reflect the true market value of the underlying security. As a result, investors are forced to pay a higher price to acquire the security, which limits their ability to buy more shares. This also leads to fewer future dividends earned, higher investment management fees, and ultimately, reduced returns for investors.

Furthermore, the last holder of record payment system is inherently limited in its ability to keep track of all shareholders over time. It is configured to only identify the last holders of record, which results in income payments being made infrequently, despite the fact that investors may be earning income on a daily basis. The standard payment frequency for equity securities is quarterly, and some investment funds pay certain distributions annually. This inflexible system delays income payments, preventing real-time compensation and reducing compound annual returns due to delayed reinvestment.

Finally, the last holder of record payment system contributes to unnecessary price volatility in the security. On the ex-dividend date, the price of the security typically drops by an amount equivalent to the payable distribution because the distribution was included in the security's value. This price drop is unrelated to the underlying fundamentals of the security, resulting in artificial volatility that may confuse investors and negatively impact trading behavior. It also adversely impacts several performance metrics, such as the Sharpe ratio, and increases the prices that investors pay for the securities' underlying options contracts.

There is a need for an improved payment system that addresses these shortcomings by providing equitable income distribution, reducing artificial overvaluation, allowing for more frequent income payments, and mitigating unnecessary price volatility.

### SUMMARY

A computer-implemented method for creating equitable payment instructions for equitably distributing income from an income-producing security to an investor, the method including: receiving an income distribution from a security issuer of an income-producing security; transferring the income distribution to a custodian; retrieving transaction data describing a transaction; retrieving an investor share number, the investor share number comprising a number of shares held by the investor at a start of a payment period; dividing the payment period into a sequence of share-intervals, wherein the first interval starts immediately after the previous payment period ends, and each subsequent interval corresponds to a share-interval duration defined by the security issuer; assigning the transaction to a corresponding share-interval using the transaction data; calculating, using the transaction data, for the investor and for the share-interval, a current share-interval value by subtracting a total number of shares sold from an investor purchase number, where the investor purchase number comprises a total number of shares that the investor purchased during the share-interval; computing an ending share-interval value by adding the current share-interval value to an ending share-interval value of a previous share-interval, wherein, for a first share-interval of a payment period, the ending share-interval value of the previous share-interval is set to the investor share number; deleting, the ending share-interval value of the previous share-interval after computing the ending share-interval value of the current share-interval to perform interval consolidation and compression; identifying, for the investor, the ending share-interval value of the last share-interval of the payment period as the investor's total ending share-interval value for the payment period; calculating a cumulative ending share-interval value for the investors by summing the total ending share-interval value for each investor; computing a payable income to the investor by dividing the investor's total ending share-interval value by the cumulative ending share-interval value for the investors and multiplying the result by the income distribution for the payment period; and generating equitable payment instructions for the investor based on the calculated income payable; storing, in the memory, the equitable payment instructions; and transmitting the equitable payment instructions to the custodian for equitable distribution to the investor of the payable income.

A computer-implemented system for creating equitable payment instructions for equitably distributing income from an income-producing security to an investor, the system comprising: a processing system comprising at least one processor and a memory storing executable instructions operably connected to the processor, the processing system configured to control the system, the processing system further configured to receive an income distribution from a security issuer of an income-producing security, the processing system further configured to transfer the income distribution to a custodian; a network interface operably connected to the processing system; an application programming interface (API) configured to communicate with transaction sources, security issuers, a blockchain interface module, and custodians via the network interface; a transaction retrieval module controlled by the processing system and configured to retrieve transaction data describing a transaction from a transaction source via the API, the transaction module further configured to retrieve an investor share number, the investor share number comprising a number of shares held by the investor at a start of a payment period; a share-interval module configured to divide the payment period into a sequence of share-intervals, wherein the first interval starts immediately after the previous payment period ends, and each subsequent interval corresponds to a share-interval duration defined by the security issuer, the share-interval module further configured to assign the transaction to a corresponding share-interval using the transaction data, the share-interval module further configured to calculate, using the transaction data, for the investor and for the share-interval, a current share-interval value by subtracting a total number of shares sold from an investor purchase number, where the investor purchase number comprises a total number of shares that the investor purchased during the share-interval, the share-interval module further configured to compute an ending share-interval value adding the current share-interval value to an ending share-interval value of a previous share-interval, wherein, for a first share-interval of a payment period, the share-interval module sets the ending share-interval value of the previous share-interval to the investor share number, the share-interval module further configured to delete the ending share-interval value of the previous share-interval after computing the ending share-interval value of the current share-interval, the share-interval module further configured to identify, at the end of the payment period, for the investor, the ending share-interval value of the last share-interval of the payment period as the investor's total ending share-interval value for the payment period, the share-interval module further configured to calculate a cumulative ending share-interval value for the investors by summing the total ending share-interval values for each investor, wherein the payment instructions module is further configured to compute, a payable income to the investor by dividing the investor's total ending share-interval value by the cumulative ending share-interval value for the investors and multiplying the result by the income distribution for the payment period, the payment instructions module further configured to generate equitable payment instructions for the investor based on the calculated income payable, the payment instructions module further configured to store, in the memory, the equitable payment instructions, the payment instructions module further configured to transmit the equitable payment instructions to the custodian for equitable distribution to the investor of the payable income.

### BRIEF DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1: A block diagram of the internal components of a payment system, illustrating how various modules are interconnected.

FIG. 2: A block diagram of the payment system, including both internal and external components to demonstrate the complete system architecture.

FIG. 3: A flowchart depicting the method used by the payment system to retrieve transactions, assign share-intervals, and calculate income payments.

FIG. 4: An illustrative example demonstrating how multiple transaction sources, with securities held in street name, can use the payment system to create a networked payment system for income distribution.

FIG. 5: An illustrative example showing how payment instructions can be compressed using interval consolidation, reducing multiple payment instructions to a single payment instruction.

### DETAILED DESCRIPTION

The embodiments of the invention are configured to distribute income from income-generating securities to investors equitably, allowing for more accurate security pricing and ensuring investors are paid income from the time they buy the security until the time they sell the security. The term equitable payment instructions refers to payment directives generated by the system to ensure that income from an income-producing security is distributed to investors in proportion to their economic interest during the payment period. These instructions account for ownership changes over time and are designed to compensate investors based on the duration of their ownership, including partial ownership periods, ensuring that each investor receives their fair share of the distribution relative to their economic interest in the security. The equitable payment instructions contain all necessary data required for accurate and fair payment execution, such as investor identifiers, payment amounts, payment intervals, and any relevant calculation details that support the equitable distribution of income.

The payment system is modular and can network several transaction sources together for a cohesive and secure payment network. The payment system retrieves, consolidates, and distributes income through internal and external components, including modules for transaction retrieval, share-interval calculation, and payment instruction generation. The system comprises a processing system comprising at least one processor and a memory storing executable instructions operably connected to the processor, the processing system configured to control the system. The system further includes a network interface operably connected to the processing system, and an application programming interface (API) configured to communicate with transaction sources, security issuers, a blockchain interface module, and custodians via the network interface. The transaction retrieval module retrieves transaction data from sources such as brokers or custodians and assigns the data to share-intervals based on timestamps. The transaction retrieval module is controlled by the processing system and configured to retrieve transaction data from a transaction source via the API, the transaction data comprising one or more of a timestamp, an investor identifier identifying an investor, a transaction amount, and a security identifier. The transaction retrieval module is further configured to retrieve an investor share number representing the number of shares held by each investor at the start of a payment period and provide the transaction data and investor share number to a share-interval module. Each share-interval represents a specific time period of tracked ownership and transactions. The share-interval module is controlled by the processing system and configured to divide the payment period into a sequence of share-intervals, with the first interval starting immediately after the previous payment period ends and each subsequent interval corresponding to a payment frequency and a share-interval duration defined by the security issuer. The system aggregates data, calculates income, and creates payment instructions using ending share-interval values, which are then securely stored and transmitted to a custodian for distribution. The share-interval module assigns transactions to share-intervals using the transaction data and, for each investor and for each share-interval, calculates a current share-interval value by subtracting a total number of shares sold from an investor purchase number, where the investor purchase number comprises a total number of shares that the investor purchased during the share-interval. The module computes an ending share-interval value by adding the current share-interval value to the ending share-interval value of a previous share-interval, wherein, for the first share-interval of the payment period, the ending share-interval value of the previous share-interval is set to the investor share number. The module then deletes the ending share-interval value of the previous share-interval after computing the ending share-interval value of the current share-interval to perform interval consolidation and compression, thereby reducing data storage requirements and speeding up processing times. At the end of the payment period, the share-interval module identifies, for each investor, the ending share-interval value of the last share-interval as the investor's total ending share-interval value for the payment period. The module calculates the cumulative ending share-interval value for all investors by summing the total ending share-interval values for each investor and provides to a payment instructions module the total ending share-interval value for each investor and the cumulative ending share-interval value for all investors.

The payment instructions module is controlled by the processing system and configured to compute payable income to each investor by dividing the investor's total ending share-interval value by the cumulative ending share-interval value for all investors and multiplying the result by the income distribution for the payment period. The module generates payment instructions for each investor based on the calculated income payable, stores the payment instructions and related data in a payment instructions database in the memory and in a blockchain interface module, and transmits the payment instructions to the custodian via the network interface and the application programming interface, encrypting the payment instructions prior to transmission to ensure secure communication. A custodian comprises one or more of a financial institution and another entity responsible for safeguarding the assets of clients, such as securities, cash, or other financial assets. A custodian can be a security issuer, a bank, or another entity configured to handle income and assets on behalf of investors. The transaction retrieval module is further configured to validate the transaction data for inconsistencies or errors and reconcile discrepancies prior to providing the data to the share-interval module. The system employs interval consolidation and compression to reduce redundant payment instructions, optimize storage, minimize computational overhead, and streamline payment processing. Deleting the ending share-interval value of the previous share-interval significantly reduces data storage requirements and speeds up processing times compared to storing all individual share-interval values. Unlike the prior art last holder of record payment system that issues payments to the shares of a security, the system issues payments directly to investors based on their respective ownership in the security. The share-interval module compensates investors for partial periods of ownership during the payment period by proportionally calculating the duration of ownership when computing the ending share-interval value. Embodiments of the invention are configured to make income distributions to investors of income-producing securities, including fixed income securities. When distributing income to fixed-income security holders, a price adjustment to the security is not necessary.

The system is configured to handle income payments by delivering the income to investors. Alternatively, the system can be configured to generate payment instructions that can be used by an entity to make the payments to investors themselves. In this alternative embodiment, the system provides flexibility to end users who may not have access to or prefer not to use the custodian associated with the system for income distribution. Instead of the system managing income payments, the system is capable of generating detailed payment instructions that include the necessary information to execute the equitable distribution of income. These payment instructions contain all of the information required for the entity to execute their own payments, including specifics such as the amount to be paid to each investor, the payment schedule, and the relevant account information required for payment execution.

In scenarios where an end user, such as an investment manager or another entity, opts to handle income payments independently, they will still send relevant data to the system. This data will be used by the system to generate the payment instructions needed for the equitable distribution of income. The generated instructions are designed to be comprehensive, including the distribution amounts based on each investor's share-interval ownership, the payment methods, and the identifiers for the respective investor accounts. The system transmits these instructions in a digital format compatible with common payment processing systems, allowing the entity to seamlessly integrate them into their financial workflows.

By providing these instructions, the system effectively offloads the processing burden to the end user while maintaining the accuracy and equity of the income distributions.

In an alternative embodiment, the payment system leverages decentralized ledger technologies, such as blockchain, to store system data, share-intervals, transaction histories, and generate and store payment instructions. Specifically, the share-interval module 114, which tracks ownership duration and calculates share-intervals, stores this data on a blockchain interface module 210 to enhance one or more of data integrity, transparency, security, and immutability. Each share-interval, representing a period of tracked ownership, is recorded as a distinct transaction on the decentralized ledger, allowing for a permanent and tamper-resistant record of each investor's shareholding duration and accrued income. The application programming interface is further configured to communicate with the blockchain interface module via the network interface to store the payment instructions and related data, enhancing data integrity, transparency, and immutability.

In one example embodiment, the payment instructions module 116 also interacts with the blockchain interface module 210 by using smart contracts to create and store payment instructions based on the computed share-interval values. These smart contracts autonomously execute income payments to investors based on the ending share-interval values, ensuring real-time, secure, and transparent distribution of income. The payment instructions database 118 can also be implemented as a decentralized ledger, where finalized payment instructions are stored securely in a distributed manner, allowing for tamper-proof historical records and regulatory compliance. Prior to transmission, the processing system encrypts the payment instructions using a secure encryption protocol to ensure secure data communication.

By utilizing blockchain technology, this alternative embodiment provides a resilient infrastructure for data integrity, enabling auditable, secure, and automated income distribution. The decentralized nature of blockchain allows for distributed access, making it possible for all participants—including custodians 204, investors, and security issuers 202—to verify transactions in real-time, thereby increasing trust in the payment process. Furthermore, the integration of blockchain into the payment system components—share-interval module 114, payment instructions module 116, and payment instructions database 118—ensures that the entire payment network benefits from enhanced reliability, transparency, and operational efficiency.

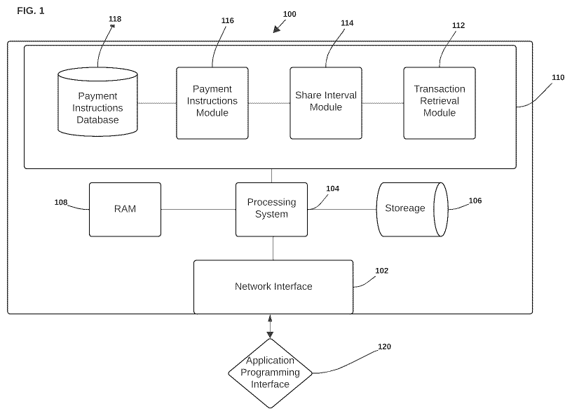

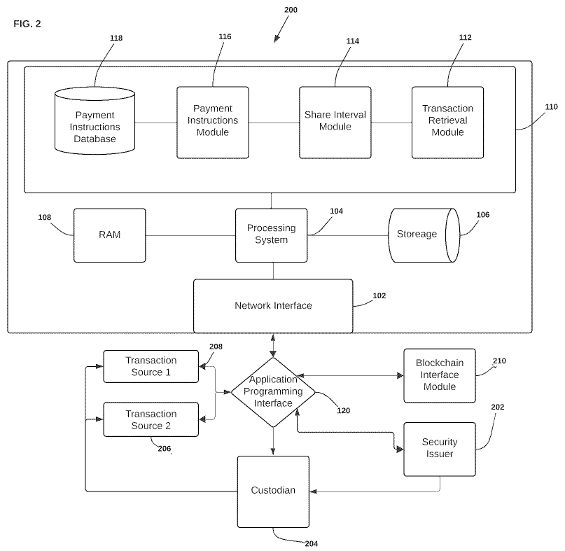

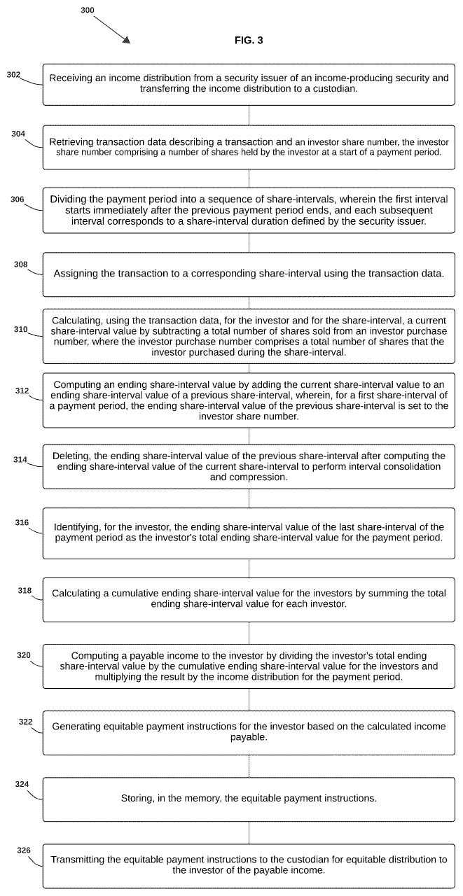

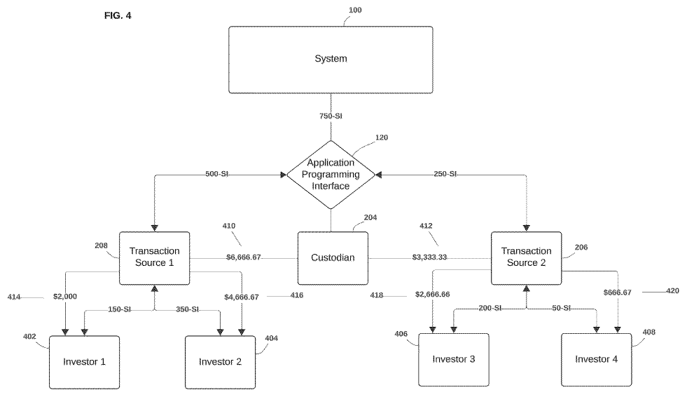

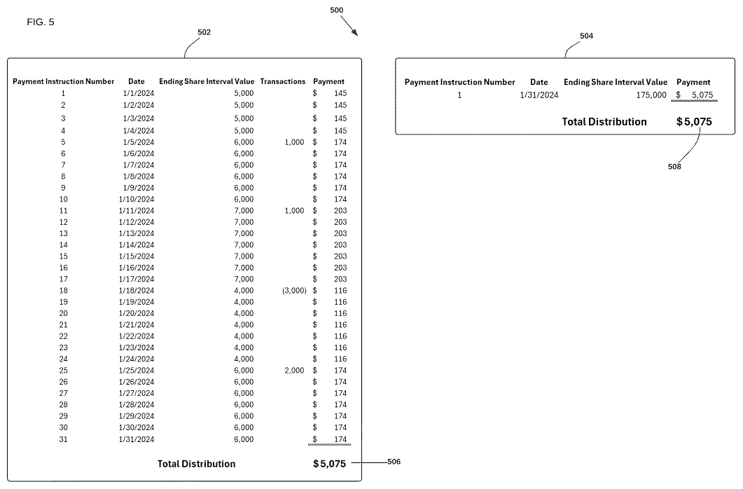

FIG. 1 illustrates a block diagram of the internal components of payment system 100, showing connections between different modules. FIG. 2 provides a block diagram of the entire payment system 100, including both internal and external components. FIG. 3 presents a flowchart detailing the method used to retrieve transactions, assign share-intervals, and calculate income payments. FIG. 4 demonstrates how multiple transaction sources, with securities held in street name, can be integrated into payment system 100 to create a networked payment system. FIG. 5 illustrates the interval consolidation and compression method, reducing multiple payment instructions to a single instruction for improved efficiency.

FIG. 1 illustrates a block diagram of the internal components of the payment system 100, without the external components depicted in FIG. 2. The internal system architecture is comprised of multiple interconnected modules, each performing a specific function and all controlled by the processing system 104.

The network interface 102 facilitates communication between internal system components and allows data exchange between different modules within the system. It provides the necessary data links required for processing and communication throughout the payment system and also allows the system to communicate with the external components depicted in FIG. 2.

The processing system 104 manages the entire workflow of the payment system, controlling the various modules and ensuring they operate in synchronization. It includes processors that handle computational tasks, data buses, input/output controllers to direct data flow, and other generic computer components.

Storage 106 is responsible for retaining system data, records, and other persistent information that the system needs to function effectively. It includes non-volatile or volatile memory to store and access data. RAM 108 provides temporary memory for processing tasks, enabling efficient data retrieval, execution of computations, and supporting high-speed data operations necessary for the system to manage multiple calculations simultaneously.

The internal network 110 connects all components within the payment system, allowing seamless data transfer between different modules. It ensures that each module can access the data it needs for processing.

The transaction retrieval module 112 is responsible for retrieving transaction data from transaction sources 206 and 208 using the application programming interface 120, including buy and sell records, security identifiers, timestamps, and other relevant transaction details. This data is then forwarded to other modules for further processing.

The share-interval module 114 assigns transactions to their corresponding share-intervals based on transaction timestamps. It determines the current value of each share-interval by summing buy transactions and summing sell transactions, then calculating the net value. The ending value of each share-interval is computed by adding the current value of the share-interval to the ending value of the previous share-interval. If no transactions are assigned to the share-interval, the current value of the share-interval is zero. Once finalized, the share-interval data is transferred to the payment instructions module 116 to calculate the payment instructions.

The payment instructions module 116 calculates the payable income to each investor account using the data retrieved from the share-interval module 114 and transaction data comprising information on each investor, time stamps, security identifiers such as ticker symbols, purchase or sale amounts, including data regarding where their accounts are held and other details needed to instruct the payments of income to investors.

The payment instructions database 118 stores finalized payment instructions, making it a secure repository of all income-related records, as well as historical transactions and other data used by the system or required for regulatory and compliance purposes. The data in the payment instructions database 118 can be used to recreate share-interval data and payment instructions on demand.

The application programming interface (API) 120 is used to facilitate the transmission of data, communication, and control between internal and external components of the system, through the network interface. It interacts with other modules, enables data exchange with external entities, and ensures seamless integration between different parts of the system, including the transmission of payment instructions to relevant entities. Alternatively, an external network, not depicted in FIG. 1 or FIG. 2, can be used to access and control the system and facilitate income payments.

The internal components are interconnected through the internal network 110, with the processing system 104 centrally managing all operations, ensuring the synchronization and functionality of each module. This design allows for efficient data handling, ensuring that each step, from transaction retrieval to payment instruction, is executed seamlessly.

FIG. 2 illustrates a block diagram of a payment system 200, comprising internal components of the system as well as external components that interact with it. Payment system 200 is connected to one or more external components, including a security issuer 202, custodian 204, and transaction sources 208 and 206 using an application programming interface 120 or an external network (not shown).

The payment system 200 has a modular and distributed architecture, comprised of a processing system 104, a network interface 102, and specialized modules, including share-interval module 114, transaction retrieval module 112, payment instructions module 116, payment instructions database 118, storage 106, and RAM 108. These modules form various subsystems, each of which is controlled by the processing system 104. The processing system 104 includes processors, data buses, input/output controllers, and other generic components to manage the overall workflow of the system.

The network interface 102 provides a communication link between the internal components of the payment system 200 and external components, including custodian 204, security issuer 202, and transaction sources 206 and 208. The network interface 102 supports secure communication protocols suitable for financial transaction processing, facilitating the retrieval of transaction data and the transmission of payment instructions.

The transaction retrieval module 112 retrieves transaction data and investor holdings from transaction sources 206 and 208. Transaction sources can include brokers, custodians, investment advisors, transfer agents, fund administrators or other entities that generate, possess and submit transaction data. The transactions data are time-stamped and transmitted to the transaction retrieval module 112, from the transaction sources 206 and 208 using encrypted data transmission methods. Upon retrieval, the transaction data, historical investor holdings, including security identifiers, timestamps, number of shares purchased or sold, account numbers, transaction source identifiers and other relevant data needed to create payment instructions, is provided to the share-interval module 114 for further processing. The transaction retrieval module 112 is configured to handle discrepancies in transaction data, such as missing information or conflicting timestamps, through automated data validation and reconciliation processes.

The share-interval module 114 divides the payment period into distinct share-intervals, wherein the first interval starts immediately after the previous payment period ends, and each subsequent interval corresponds to a share-interval duration defined by the security issuer 202. The security issuer sets two distinct terms: the share-interval duration and the payment frequency. The share-interval duration is the amount of time used to calculate income earned and is used to calculate the duration of share-intervals. For example, if the share-interval duration is one day, then investors earn income each day they hold securities. If the share-interval duration is one hour, then investors earn income for each hour they own shares. The share-interval module 114 uses transaction timestamps, Boolean logic, and the transaction data to group transactions into corresponding share-intervals based on the share-interval duration based on the time the transactions occurred. For example, if the transaction occurs between the beginning and the end of the interval, then the transaction is assigned to that interval. The payment frequency determines when investors receive income payments. For instance, if the share-interval duration is one hour and the payment frequency is quarterly, investors earn income each hour of the quarter but receive the payment once per quarter. Alternatively, if the share-interval duration is daily and the payment frequency is also daily, then investors earn income each day and are paid each day. Partial share-intervals are possible. They are treated as any other share-interval for calculating the ending share-interval values. For example, a payment period may consist of 90 share-intervals, where each interval is one day long, but the last interval of the payment period is a half day long. Payments can be made in cash, additional securities, or paid by another method. The share-interval durations and payment frequencies of different types of distributions can differ. For example, the payment frequency for dividends can be monthly while the payment frequency of capital gains can be annually. The system is configured to pay different distribution types based on the payment standards selected by the security issuer.

The first share-interval of a new payment period begins when the previous payment period ends, thereby providing continuous coverage for income calculation purposes. For example, consider a share-interval duration of one hour and a payment frequency of quarterly. If the payment period starts at 4 PM on January 1st and ends at 4 PM on March 31st, each share-interval is one hour in length. In this case, there are 24 hours in a day and approximately 90 days in the quarter, resulting in a total of 2,160 share-intervals within the quarter. Each of these intervals starts at the conclusion of the previous share-interval for each hour, respectively, throughout the quarter. Investors earn income for every hour they hold shares during the quarter, and all accumulated income is distributed at the end of the quarter, as determined by the payment frequency. The share-interval module 114 groups transactions into their corresponding share-intervals based on the timestamps of each transaction. For example, if a transaction occurs at 1:15 PM, and a share-interval begins at 1:00 PM and ends at the beginning of the next share-interval which begins at 2:00 PM, assuming a share-interval duration of one hour, this transaction would be assigned to the 1:00 PM share-interval since the transaction occurred after the start of the 1 PM interval but before the next share-interval at 2 PM. For example, a share-interval starts when the previous share-interval stops. For example, for a share-interval that starts at 1 PM and ends at 2 PM, all transactions that occur on this date and whose time stamp is greater than or equal to 1 PM but less than 2 PM, will be assigned to this share-interval.

For each share-interval, the share-interval module 114 determines the current value of the share-interval by summing the buy transactions and summing the sell transactions, then subtracting the sum of the sell transactions from the sum of the buy transactions. Specifically, the current value is calculated by subtracting the total number of shares sold during the interval from the total number of shares purchased. If no transactions occurred during the share-interval, the current value of the share-interval is zero. Once the current value of the share-interval is determined by subtracting one or more of a total number of share sold from a total number of shares purchased, the ending value of the share-interval is computed by adding the current value of the share-interval to the ending value of the previous share-interval. After the ending value of the current share-interval is determined, the previous share-interval is deleted to conserve storage space. For example, after subtracting one or more of a total number of share sold from a total number of shares purchased, if the value of the current share-interval is 50 and the ending value of the previous share-interval is 100, then the ending value of the current share-interval would be 150 (100+50). Once this computation is complete and the ending share-interval value is determined, the previous share-interval with and ending value of 100 is deleted, leaving only the updated ending value of 150 for the current interval. This process effectively consolidates numerous payment instructions into a single consolidated record per investor, a process referred to herein as ‘Interval Consolidation and Compression.’ This approach reduces the storage and processing times needed to manage payment instructions while still allowing transaction data to be stored in a database so that a complete record can be recreated at any time for compliance and auditing purposes.

For the first share-interval of a new payment period, the share-interval module 114 will request the current investor holdings from the transaction retrieval module 112. The investor holdings represent the amount of shares owned by an investor at a point in time. On the first share-interval of a payment period, the investor holdings represents the value of the previous share-interval. For example, on day 1 of a new payment period, to calculate the ending value of the first share-interval, the transactions of the first share-interval will be netted and then added to the investor holdings. The result is the ending share-interval value for the first share-interval of a payment period.

The payment instructions module 116 generates payment instructions based on the computed ending share-interval values for each investor. The share-interval data is transmitted from the share-interval module 114 to the payment instructions module 116 through an internal network 110, ensuring that all relevant data is available for payment calculation. The payment instructions module 116 calculates the payable income to each investor by dividing their ending share-interval value by the sum of all ending share-interval values for all investors and then multiplying by the total distribution amount. For example, if an investor's ending share-interval value is 100, the sum of all ending share-interval values for all investors is 1000, and the total distribution is $1000, the investor would receive a distribution equal to $100 (100/1000)*$1000. This method ensures that each investor receives an income amount proportional to the duration and value of their share ownership during the payment period regardless if the shares outstanding of the security changes or remains constant. The payment instructions module 116, using the method described in FIG. 3, computes the payable income for all investors, and once finalized, compiles the computed payment amounts into payment instructions using identifying data from the transaction data to determine where and to whom the payments are to be sent. The payment instructions module 116 can also accommodate various payment methods, such as direct bank transfers, issuance of additional shares, or other payment methods as specified by the security issuer 202.

Prior to processing, the processing system validates the transaction data for inconsistencies or errors and reconciles discrepancies The compiled payment instructions, transactions data, share-interval data, and other data created by the payment system 200 are stored in the payment instructions database 118, which serves as a secure repository for all payment-related data. The database 118 interfaces with custodian 204 and security issuer 202 to transmit payment instructions for processing. Additionally, the payment system 200 includes a blockchain interface module 210, which is configured to store relevant data on a decentralized ledger and interact with other components of the payment system. This blockchain interface module 210 provides an additional layer of data security and transparency, enabling distributed storage of important data such as transaction histories, share-interval data, and payment instructions. The blockchain interface module 210 facilitates the integration of the payment system with blockchain technology by transmitting data to a decentralized ledger for secure, tamper-resistant storage, and retrieving it when needed.

The payment instructions database 118 retains historical data, allowing for reconstruction or revision of transactions if adjustments are necessary. The blockchain interface module 210 works in tandem with the payment instructions database 118 to ensure that a secure, verifiable copy of each transaction is available, leveraging blockchain's inherent immutability to enhance trustworthiness and auditability. This integration allows for efficient verification of payment instructions and ownership data, while the payment instructions database 118 includes indexing mechanisms that allow for quick access to specific payment records, ensuring efficient data retrieval for regulatory inquiries or audits. This combined approach—leveraging both traditional database structures and blockchain technology—enhances the overall security, reliability, and transparency of the payment system, ensuring that data integrity is maintained across all components.

Once the payment instructions are compiled and finalized, they are encrypted and transmitted to the custodian 204 via the application programming interface 120. The custodian 204, using the payment instructions, distributes the income to investors using a preferred method of electronic payment. The system can accommodate various payment methods, including electronic fund transfers, issuance of additional shares, or other forms of payment. An acknowledgment mechanism confirms the successful transmission and processing of payments. Such acknowledgment involves a confirmation message logged by the payment system 200, indicating that the funds were transferred to the appropriate investor accounts. In certain embodiments, the payment system 200 can also generate alerts if a payment fails or if there is a discrepancy between the transmitted instructions and the actual payment made.

Payment system 200 operates as a modular system, where each component functions independently, allowing the system to continue functioning even if one or more components fail. The processing system 104 manages interactions between subsystems to maintain operational continuity. If the Transaction Retrieval Module 112 encounters an issue, the system re-attempts retrieval or queues transactions until the module is operational again. Each subsystem within payment system 200 has redundancy, ensuring that a backup component can take over if the primary component fails. The modular design allows for easy maintenance and upgrades, as individual components can be serviced or replaced without affecting the overall functionality.

The payment system 200 includes security protocols to ensure data integrity and confidentiality. The system employs industry-standard security mechanisms, including encryption for data in transit and at rest, secure access controls, and audit logging for compliance. The audit logging functionality ensures that all actions within the system are recorded, providing a detailed trail that can be used for regulatory compliance, internal audits, and forensic analysis. Secure access controls limit user permissions, ensuring that only authorized individuals can access or modify sensitive financial data.

FIG. 3 is a flowchart depicting the method used by the payment system 100 to retrieve transactions, assign share-intervals, and calculate income payments. The order of the steps in the method 300 is not constrained to that shown in FIG. 3 or described in the following discussion. Several of the steps could occur in a different order without affecting the final result.

In step 302, receiving an income distribution from a security issuer of an income-producing security and transferring the income distribution to a custodian. Block 302 then transfers control to block 304.

In step 304, retrieving transaction data describing a transaction and an investor share number, the investor share number comprising a number of shares held by the investor at a start of a payment period. Block 304 then transfers control to block 306.

In step 306, dividing the payment period into a sequence of share-intervals, wherein the first interval starts immediately after the previous payment period ends, and each subsequent interval corresponds to a share-interval duration defined by the security issuer. Block 306 then transfers control to block 308.

In step 308, assigning the transaction to a corresponding share-interval using the transaction data. Block 308 then transfers control to block 310.

In step 310, calculating, using the transaction data, for the investor and for the share-interval, a current share-interval value by subtracting a total number of shares sold from an investor purchase number, where the investor purchase number comprises a total number of shares that the investor purchased during the share-interval. Block 310 then transfers control to block 312.

In step 312, computing an ending share-interval value by adding the current share-interval value to an ending share-interval value of a previous share-interval, wherein, for a first share-interval of a payment period, the ending share-interval value of the previous share-interval is set to the investor share number. Block 312 then transfers control to block 314.

In step 314, deleting, the ending share-interval value of the previous share-interval after computing the ending share-interval value of the current share-interval to perform interval consolidation and compression. Block 314 then transfers control to block 316.

In step 316, identifying, for the investor, the ending share-interval value of the last share-interval of the payment period as the investor's total ending share-interval value for the payment period. Block 316 then transfers control to block 318.

In step 318, calculating a cumulative ending share-interval value for the investors by summing the total ending share-interval value for each investor. Block 318 then transfers control to block 320.

In step 320, computing a payable income to the investor by dividing the investor's total ending share-interval value by the cumulative ending share-interval value for the investors and multiplying the result by the income distribution for the payment period. Block 320 then transfers control to block 322.

In step 322, generating equitable payment instructions for the investor based on the calculated income payable. Block 322 then transfers control to block 324.

In step 324, storing, in the memory, the equitable payment instructions. Block 324 then transfers control to block 326.

In step 326, transmitting the equitable payment instructions to the custodian for equitable distribution to the investor of the payable income. Block 326 then terminates the process.

FIG. 4 illustrates an example embodiment of the payment system 100 involving multiple transaction sources, where securities are held in street name. “Street name” refers to a situation where securities are held in the name of a brokerage or financial institution (the transaction source), rather than in the name of the individual investor. The transaction source possesses data on the transactions made by individual investors. This allows for easier trading and administrative efficiency, as the transaction source manages the securities on behalf of the investors. FIG. 4 demonstrates how multiple transaction sources can be networked together, using the payment system 100, to create an integrated payment system that operates cohesively, even when the payment system 100 does not have direct access to transaction data of individual investor accounts. Instead, the securities at each transaction source are aggregated and held under the name of the transaction source itself. In this example embodiment, the transaction sources 206 and 208 must use the payment system 100 internally, at the transaction source to determine income distribution. This means two or more distributions will be made and the payment system 100 operates at two or more levels. First, the payment system 100 determines the distribution payable to the transaction sources 206 and 208. Then, the transaction sources 206 and 208 use the payment system 100 to determine the distributions payable to individual investor accounts.

The system includes two transaction sources, transaction source 1 208 and transaction source 2 206, which interface with the payment system 100 through the application programming interface 120. Securities held by each transaction source are aggregated, and the payment system 100 accesses all transaction data from transaction source 1 208 and transaction source 2 206 to determine the total number of ending share-interval values and the income earned by each transaction source. However, since the securities are held in street name, the payment system 100 does not perform individualized income calculations for investors directly. Rather, payment system 100 calculates the amount of money payable to each transaction source and the transaction sources use payment system 100 internally to determine how the gross distributions paid to the transaction sources are allocated to individual investors and investor accounts using payment system 100.

In this example embodiment, the process starts with the security issuer declaring an income distribution of $10,000 payable to investors, which is transferred to the custodian 204. The custodian 204, using payment instructions transmitted by payment system 100, calculates the distributions payable to transaction source 1 208 and transaction source 2 206. The payment system 100 aggregates the final ending share-interval values for a payment period from both transaction sources. The total ending share-interval values are shown in the lines connecting the transaction sources 206 and 208 to the application programming interface 120 and end with “SI,” which stands for share-intervals. Transaction source 1 208 generated a total of 500 ending share-intervals, and transaction source 2 206 generated 250 ending share-intervals, resulting in a combined total of 750 ending share-intervals. Using an income distribution of $10,000 authorized by the security issuer, the payment system 100 calculates the payable income to each transaction source using the ending share-interval data. Transaction source 1 208, which generated 500 ending share-intervals out of the total 750 ending share-intervals, is entitled to a payment of $6,666.67 (410) or (500/750)*$10,000. Similarly, Transaction Source 2 206, which generated 250 ending share-intervals out of the total 750 ending share-intervals, is entitled to a payment of $3,333.33 (412) or (250/750)*$10,000. The custodian 204 then distributes the calculated payments to Transaction Source 1 208 and Transaction Source 2 206 accordingly.

After receiving the allocated income, each transaction source uses its own instance of the payment system 100 to allocate the income to individual investors based on the transactions generated by each investor at the transaction source. Transaction Source 1 208 distributes the income of $6,666.67 410 between investor 1 402 and investor 2 404. Investor 1 402 generated 150 ending share-intervals out of the total 500 ending share-intervals generated by Transaction Source 1 208 and is therefore entitled to a payment of $2,000 (414) or (150/500)*$6,666.67. Investor 2 404 generated 350 ending share-intervals out of the total 500 ending share-intervals generated by Transaction Source 1 208 and is therefore entitled to a payment of $4,666.67 (416) or (350/500)*$6,666.67.

Transaction Source 2 206 distributes the income of $3,333.33 between investor 3 406 and investor 4 408. Investor 3 406 generated 200 ending share-intervals out of the total 250 ending share-intervals generated by Transaction Source 2 206 and is therefore entitled to a payment of $2,666.66 (418) or (200/250)*$3,333.33. Investor 4 408 generated 50 ending share-intervals out of the total 250 ending share-intervals generated by Transaction Source 2 206 and is therefore entitled to a payment of $666.67 (420) or (50/250)*$3,333.33. This allocation process represents a complete distribution of the $10,000 in income, with all calculations verified to ensure accuracy. The accuracy can be confirmed by summing all individual distributions to investors 1-4, which equal the distribution of $10,000=($2,000+$4,666.67+$2,666.66+$666.67). For these example embodiments of computed values, fractional pennies are rounded to the nearest whole penny in accordance with industry regulations.

FIG. 4 is a simplified example illustrating how the payment system 100 can be used by multiple transaction sources to create a scalable payment system and network. FIG. 4 represents one example embodiment, and the system can be configured in alternate ways to suit various implementations.

FIG. 5 illustrates an example embodiment of the payment system 100 that demonstrates how payment instructions can be compressed using the interval consolidation and compression method. This technique allows for the reduction of potentially hundreds or thousands of individual payment instructions per investor into a single consolidated payment instruction, effectively creating a new data structure that is used to generate payment instructions. The creation of this new data structure introduces a tangible advancement in the handling and management of financial data by providing a specific mechanism for aggregating, storing, and processing transaction data in a more efficient way. This data structure involves physical memory allocation for consolidated payment instructions, effectively reducing the required computational resources and mitigating storage overhead. This configuration represents a significant advancement by offering a practical solution that specifically addresses the challenges of data redundancy and inefficiency. By consolidating multiple payment instructions into a single data structure, it optimizes resource usage, reduces processing complexity, and enhances the system's ability to manage high transaction volumes effectively.

In FIG. 5, individual payment instructions 502 for an investor are shown for each share-interval prior to the application of the interval consolidation and compression method. This example embodiment assumes a level dividend distribution of $0.029 per share per day. The payment instructions 502 detail individual transactions occurring on Jan. 5, 2024, Jan. 11, 2024, Jan. 18, 2024, and Jan. 25, 2024, paired with their respective share-intervals using the method described in FIG. 3. The ending share-intervals for these dates have been modified accordingly based on the transactions occurring on these dates. The individual payment instructions 502 for each day are computed, and the payments for the entire payment period are summed, resulting in a payment of $5,075 (506) for this investor.

In contrast, the interval consolidation and compression method 504 is shown, as described in FIG. 3, reducing thirty-one individual payment instructions into a single consolidated ending share-interval and payment instruction. This single ending interval is then used to compute the payment of $5,075 (508), calculated as 175,000 total ending share-intervals multiplied by the per share per day dividend of $0.029. The total payment for the individual payment instructions 502 and the interval consolidation and compression method 504 are identical. However, the interval consolidation and compression method 504 reduces the number of individual payment instructions 502 from thirty-one to just one, representing a 96.77% decrease in the amount of data required to compute payment instructions. Such a reduction translates to substantially decreased storage requirements, storage costs, and processing time, as well as reduced network bandwidth usage and faster data retrieval times, thereby significantly improving payment system efficiency.

### ADVANTAGES

The embodiments of the invention provide numerous advantages over the prior art last holder of record payment system payment system by addressing its significant technical limitations and inefficiencies. Specifically, the embodiments of the invention ensure equitable income distribution, reduce artificial overvaluation of securities, allow for more frequent income payments, including daily payments, and mitigate unnecessary price volatility, thereby providing investors with improved economic outcomes and a more accurate representation of the value of income-producing securities.

The prior art last holder of record payment system suffers from several technical problems that hinder accurate and equitable income distribution. These limitations include the inability to track real-time ownership changes, inefficient data handling, and reliance on outdated processes that do not account for modern, high-frequency trading environments. The last holder of record payment system fundamentally lacks the technical capability to address rapid ownership changes that occur in today's markets, leading to inequitable payment distributions and artificial price inflation of securities. The embodiments of the invention overcome these technical challenges by implementing a modular payment system that is specifically designed to address these shortcomings through a sophisticated combination of data retrieval, consolidation, and distribution mechanisms. This modular approach ensures that the payment system can dynamically adjust to ownership changes and efficiently manage high volumes of data, resulting in a significant improvement in technical performance.

The embodiments of the invention ensure that investors receive income in proportion to their economic interest in the income generated by a security for the time they held it. Unlike the last holder of record system, which only compensates investors who hold a security on the last day of a payment period, this payment system calculates and distributes income based on share-intervals for each investor throughout the payment period. This technical solution overcomes the fundamental limitation of the last holder of record payment system by introducing share-intervals as a mechanism to accurately track, record and allocate income, effectively solving the problem of real-time ownership changes and ensuring equitable income distribution. Using share-intervals, which are based on units of time, the embodiments of the invention ensure that investors are paid in proportion to the duration of their ownership of the security. This feature ensures that investors who sell a security before the end of the payment period still receive the income they earned during their ownership. The embodiments of the invention can even compensate investors for partial days of ownership. For example, an investor who sells a security one hour before the market closes can be paid income up until the time of sale. As a result, income distribution is equitable, compensating all investors according to the duration of their ownership, and eliminating the unfairness inherent in the prior system.

The embodiments of the invention also reduces the artificial overvaluation of income-producing securities. Under the prior art payment system, unpaid distributions must be added to the value of the security, which leads to inflated prices that do not represent the security's true market value. This inflated valuation forces investors to pay more to acquire the security, ultimately limiting the number of shares they can buy, reducing their ability to earn future dividends, and increasing investment management fees. The embodiments of the invention address this technical problem by allowing a security issuer to pay income distributions frequently, ensuring that unpaid distributions are not added to the security's value. By keeping track of all security ownership, the system enables investment fund managers to authorize income distributions frequently, removing these distributions from the security's value and thereby ensuring accurate pricing. This frequent income distribution capability represents a technical advancement over the prior art by utilizing enhanced data tracking and computational processes, which allows for precise and timely income payments. This technical enhancement effectively decouples the income component from the security's price, resulting in a more transparent and accurate valuation. This results in a more accurate valuation, allowing investors to realize increased investment returns and purchase securities at fair market value. Adding income to the value of a security is mandatory in the last holder of record payment system because the system cannot function without distributions being included in the value of the security.

Furthermore, the payment system allows for more frequent and flexible income payments. In the prior art, income payments are typically made on a quarterly or annual basis, delaying the compensation that investors are entitled to. This delay reduces investors' ability to reinvest their earned income and thereby diminishes their compound annual returns. By contrast, the embodiments of the invention disclosed herein facilitate income distribution based on share-intervals, which can be any unit of time, for example, daily, hourly, minutes, seconds or another unit of time. This frequent income payment improves investors' compound returns by allowing them to reinvest their earnings sooner, thereby enhancing the overall performance of their investment portfolios. Payments can be made in cash, or the income can be used to purchase more shares, allowing the investor to continuously increase the number of shares they own. The ability to distribute income based on short time intervals (e.g., hourly) is a direct result of technical improvements in data processing and interval management, which overcome the rigidity and inefficiency of the last holder of record payment system. The technical advancements in handling and managing frequent, time-based payments make the system suitable for modern trading environments where ownership can change rapidly, ensuring that all investors are compensated in alignment with their actual holdings.

Another advantage of the embodiments of the invention is the reduction in unnecessary price volatility. In the last holder of record payment system, the security's price drops on the ex-dividend day by an amount equivalent to the payable distribution, resulting in a downward artificial price fluctuation. This volatility, which does not reflect changes in the underlying fundamentals of the security, but rather represents a technical problem in the payment system, confuses investors and distorts market behavior. By eliminating the need for an ex-dividend day and ensuring income is paid based on share-intervals, the payment system provides a technical solution to stabilize security prices and avoid artificial fluctuations because no drop in the price is required at the end of the payment period. The embodiments of the invention reduce unnecessary price drops and stabilize the trading value of securities. This contributes to better performance metrics, such as an improved Sharpe ratio, and lowers the prices investors pay for options contracts on the underlying security.

Additionally, the embodiments of the invention employ interval consolidation and compression techniques that allow the system to efficiently manage payment instructions. Interval consolidation and compression represent significant technical improvements that directly address the limitations of handling high volumes of financial transaction data. Rather than creating individual payment instructions for each share-interval, the system aggregates these instructions into a single consolidated payment instruction. This consolidation improves the functioning of the computer system by reducing data redundancy, lowering computational load, and decreasing the amount of storage required for processing and retaining payment data. This consolidation can reduce the volume of data by approximately 98.89%, or more, for example, consolidating ninety individual payment instructions into one. Additionally, for a capital gain distribution that is typically paid annually, the system can consolidate 365 individual payment instructions into one, resulting in a 99.73% reduction in data volume. This dramatic reduction in data volume translates to faster processing times, as there is less data to handle and compute. Specifically, the system's computational efficiency is enhanced by reducing the number of discrete operations required for processing payments, resulting in faster execution and reduced latency. This technical solution also optimizes CPU usage in the processing system, reduces memory bottlenecks, and minimizes the number of read-write operations, directly improving the performance of the underlying computer hardware. Such reduction in data not only decreases storage requirements but also speeds up processing times by a similar percentage. For instance, by reducing the data volume by 99.73%, the processing time is similarly reduced, allowing the system to handle larger transaction volumes without a corresponding increase in processing power. The reduced latency and increased throughput enable the system to scale effectively, meeting the demands of high-frequency trading and large-scale investment environments. This leads to substantial cost savings related to data handling, storage, and network bandwidth, while improving overall efficiency. The creation of a new data structure to generate and compress payment instructions optimizes the computer's resources, allowing it to perform more tasks in less time and manage a larger number of transactions effectively. This technical solution provides tangible improvements to the functioning of both the payment system and the computer systems used to implement it, offering a practical means to address data redundancy, reduce computational overhead, and enhance operational efficiency.

In summary, the embodiments of the invention provide a specific technical solution to overcome the technical limitations of the prior art last holder of record payment system by implementing a sophisticated, modular payment network that can dynamically adapt to real-time ownership changes and efficiently manage equitable payment distribution. The technical advancements inherent in the embodiments of the invention include the use of share-intervals, real-time data tracking, and interval consolidation and compression, all of which improve the functioning of the payment system computers itself by reducing processing time, optimizing data storage, and enhancing computational efficiency. Additionally, the embodiments ensure that all investors, including those who owned but sold their shares before the end of the payment period, are compensated equitably, even for partial days of ownership, and that securities are accurately valued without artificial inflation. These innovations provide a solution to long-standing technical problems in payment system technology-ensuring that income distribution keeps pace with real-time ownership changes, while maintaining computational efficiency in a high-frequency trading environment. The technical features of the embodiments collectively enhance the reliability and scalability of payment processing systems, providing specific improvements that solve practical problems inherent in prior art payment systems. Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

### ADDITIONAL APPLICATIONS OF DESCRIBED SUBJECT MATTER

Although process steps, algorithms or the like, including without limitation with reference to FIGS. 1-5, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

What is claimed is:

1. A computer-implemented method for creating equitable payment instructions for equitably distributing income from an income-producing security to an investor, the method comprising:
receiving an income distribution from a security issuer of an income-producing security;
transferring the income distribution to a custodian;
retrieving transaction data describing a transaction;
retrieving an investor share number, the investor share number comprising a number of shares held by the investor at a start of a payment period;
dividing the payment period into a sequence of share-intervals, wherein the first interval starts immediately after the previous payment period ends, and each subsequent interval corresponds to a share-interval duration defined by the security issuer;
assigning the transaction to a corresponding share-interval using the transaction data;
calculating, using the transaction data, for the investor and for the share-interval, a current share-interval value by subtracting a total number of shares sold from an investor purchase number, where the investor purchase number comprises a total number of shares that the investor purchased during the share-interval;
computing an ending share-interval value by adding the current share-interval value to an ending share-interval value of a previous share-interval, wherein, for a first share-interval of a payment period, the ending share-interval value of the previous share-interval is set to the investor share number;
deleting the ending share-interval value of the previous share-interval after computing the ending share-interval value of the current share-interval to perform interval consolidation and compression;
identifying, for the investor, the ending share-interval value of the last share-interval of the payment period as the investor's total ending share-interval value for the payment period;
calculating a cumulative ending share-interval value for the investors by summing the total ending share-interval value for each investor;
computing a payable income to the investor by dividing the investor's total ending share-interval value by the cumulative ending share-interval value for the investors and multiplying the result by the income distribution for the payment period;
generating equitable payment instructions for the investor based on the calculated income payable;
storing, in the memory, the equitable payment instructions; and
transmitting the equitable payment instructions to the custodian for equitable distribution to the investor of the payable income.

2. The method of claim 1, wherein the step of computing the payable income comprises computing a distribution based on a respective period of ownership.

3. The method of claim 2, wherein the step of computing the payable income further comprises computing a distribution to an investor that sells the security prior to the end of the payment period.

4. The method of claim 3, wherein the investor is compensated for a partial period of ownership during the payment period by proportionally calculating a duration of ownership when computing the ending share-interval value.

5. The method of claim 1, wherein the share-interval duration and payment frequency are configurable parameters set by the security issuer to enable income calculations and distributions on any desired time basis.

6. The method of claim 1, wherein deleting the ending share-interval value of the previous share-interval significantly reduces data storage requirements and speeds up processing times of the system compared to storing all individual share-interval values.

7. The method of claim 1, further comprising encrypting the payment instructions before transmission to ensure secure data communication.

8. The method of claim 1, wherein prior to processing, the processing system validates the transaction data.

9. The method of claim 1, further comprising recording one or more of the transaction data, the ending share-interval, and the payment instructions on a decentralized ledger.

10. The method of claim 1, wherein the transaction data comprises one or more of a timestamp, an investor identifier identifying an investor, a transaction amount, and a security identifier identifying the security.

11. A computer-implemented system for creating equitable payment instructions for equitably distributing income from an income-producing security to an investor, the system comprising:
a processing system comprising at least one processor and a memory storing executable instructions operably connected to the processor, the processing system configured to control the system, the processing system further configured to receive an income distribution from a security issuer of an income-producing security, the processing system further configured to transfer the income distribution to a custodian;
a network interface operably connected to the processing system; an application programming interface (API) configured to communicate with transaction sources, security issuers, a blockchain interface module, and custodians via the network interface;
a transaction retrieval module controlled by the processing system and configured to retrieve transaction data describing a transaction from a transaction source via the API, the transaction module further configured to retrieve an investor share number, the investor share number comprising a number of shares held by the investor at a start of a payment period;
a share-interval module configured to divide the payment period into a sequence of share-intervals, wherein the first interval starts immediately after the previous payment period ends, and each subsequent interval corresponds to a share-interval duration defined by the security issuer, the share-interval module further configured to assign the transaction to a corresponding share-interval using the transaction data, the share-interval module further configured to calculate, using the transaction data, for the investor and for the share-interval, a current share-interval value by subtracting a total number of shares sold from an investor purchase number, where the investor purchase number comprises a total number of shares that the investor purchased during the share-interval, the share-interval module further configured to compute an ending share-interval value adding the current share-interval value to an ending share-interval value of a previous share-interval, wherein, for a first share-interval of a payment period, the share-interval module sets the ending share-interval value of the previous share-interval to the investor share number, the share-interval module further configured to delete the ending share-interval value of the previous share-interval after computing the ending share-interval value of the current share-interval, the share-interval module further configured to identify, at the end of the payment period, for the investor, the ending share-interval value of the last share-interval of the payment period as the investor's total ending share-interval value for the payment period, the share-interval module further configured to calculate a cumulative ending share-interval value for the investors by summing the total ending share-interval values for each investor, wherein the payment instructions module is further configured to compute, a payable income to the investor by dividing the investor's total ending share-interval value by the cumulative ending share-interval value for the investors and multiplying the result by the income distribution for the payment period, the payment instructions module further configured to generate equitable payment instructions for the investor based on the calculated income payable, the payment instructions module further configured to store, in the memory, the equitable payment instructions, the payment instructions module further configured to transmit the equitable payment instructions to the custodian for equitable distribution to the investor of the payable income.

12. The system of claim 11, wherein the transaction retrieval module is further configured to validate the transaction data for inconsistencies or errors and reconcile discrepancies prior to providing the data to the share-interval module.

13. The system of claim 11, wherein the share-interval module compensates investors for partial periods of ownership during the payment period by proportionally calculating the duration of ownership when computing the ending share-interval value.

14. The system of claim 11, wherein deleting the ending share-interval value of the previous share-interval significantly reduces data storage requirements and speeds up processing times compared to storing all individual share-interval values.

15. The system of claim 11, wherein the payment interval and payment frequency are configurable parameters set by the security issuer to enable income calculations and distributions on any desired time basis.

16. The system of claim 11, wherein the application programming interface is further configured to communicate with the blockchain interface module via the network interface to store the payment instructions and related data, enhancing data integrity, transparency, and immutability.

17. The system of claim 11, wherein prior to transmission, the processing system encrypts the payment instructions using a secure encryption protocol to ensure secure data communication.

18. The system of claim 11, wherein the transaction data comprises one or more of a timestamp, an investor identifier identifying an investor, a transaction amount, and a security identifier identifying the security.
